(19) United States
(12) Patent Application Publication
(10) Pub. No.: US 2025/0326504 A1
(43) Pub. Date: Oct. 23, 2025

(54) Device and methods for satellite control and collision avoidance using artificial intelligence

(71) Applicant: Brian Haney, Pittsburgh, PA (US)

(72) Inventor: Brian Haney, Pittsburgh, PA (US)

(21) Appl. No.: 17/980,823

(22) Filed: Nov. 4, 2022

(51) Int. Cl. B64G 1/24; B64G 1/10; B64G 1/36

(52) U.S. Cl. CPC B64G 1/247; B64G 1/10; B64G 1/36

(57) ABSTRACT

The present disclosure is a device and methods for satellite trajectory control and collision avoidance. Embodiments of the disclosure are comprised of a smart satellite device performing a process three steps. First, sensors collect data about the satellite's physical landing environment, passing information to satellite's database and processors. Second, the processors manipulate the information with a deep reinforcement learning program to produce instructions. Third, the instructions steer the satellite body by manipulating the satellite's panels for optimal trajectory and collision avoidance. The purpose for the present disclosure is to help solve the space debris problem.

### SUMMARY OF THE INVENTION

The present disclosure is a device and methods for satellite trajectory optimization, collision avoidance, and smart satellite steering. Embodiments of the invention are comprised of a smart satellite device performing a process with three steps. First, sensors collect data about the satellite's physical landing environment, passing information to satellite's database and processors. Second, the processors manipulate the information with a deep reinforcement learning program to produce instructions to ensure safe orbit and collision avoidance. Third, the instructions command the satellite body's panels using intelligent control connectors commanding the satellite to ensure safety optimization and collision avoidance.

The focus of the present disclosure is the space debris problem as it pertains to satellite safety and collision avoidance. A recent radical and revolutionary technology, the reusable rocket, has allowed for rapid increases in orbital satellites, from approximately 3,500 orbital objects in the year 1975 to approximately 5,000 in 2018, and then to over 40,000 by the end of the year 2022. The problem this disclosure sets out to solve is now that there are at least 35,000 more satellites in orbit, the probability of satellite crashes is now 8× higher than it was just four years ago. This creates a high risk for technical and financial loss. As such, there exists an urgent need for effective and efficient satellite collision avoidance technology, converging aerospace, computer vision, and artificial intelligence technologies.

### BACKGROUND TO THE INVENTION

The field of the present disclosure relates to systems and methods for satellite control during landing using machine learning computer programs. New technologies often represent a convergence of many different streams of techniques, devices, and machines, each coming from its own separate historical avenue of development. As such, the field of this invention lies at the intersection of three broader fields: satellite spaceflight, computer vision, and machine learning.

Satellites are Earth orbiting objects. Artificial Intelligence (AI) is a sub-field of computer science focusing on machines making decisions that mirror and replicate the human mind's thoughtful processes. Machine learning is a process for programming software that learns from data, takes intelligent actions from learned knowledge, and iteratively improves in performance over time.

The history of satellite spaceflight has a rich and fascinating story inspired by ancient wonder. The Roman Emperor, Marcus Aurelius said, “The entire Earth is but a point, and the place of our own habitation but a minute corner of it.” As it pertains to spaceflight orbit, Kepler developed the laws of orbital motion during the 17^{th} Century, the first of which states that the orbit of each planet is an ellipse. According to Kepler, the sun was the focus of each planet's elliptical orbit. Kepler also disproved the notion of cosmological perfection. Newton was the first to master modern mechanics and mathematics. Newton developed the foundations of calculus and first explained the laws of motion in Principia.

Konstantin Tsiolkovsky is the most significant figure in the history of spaceflight. In 1903, Tsiolkovsky published, The Investigation of Space by Means of Reactive Devices, in which he mathematically developed the theory of spaceflight. Equation 1 is Tsiolkovsky's rocket equation.

$$Δ v = {v}_{e} ln \frac{{m}_{0}}{{m}_{f}} = {I}_{sp} {g}_{0} ln \frac{{m}_{0}}{{m}_{f}} \qquad ( 1 )$$

where Δv is the maximum change of velocity of the vehicle, Iₛₚ is the specific impulse, m₀ is the initial total mass, and m_{f} is the final total mass without propellant for any maneuver. Tsiolkovsky's rocket equation proved foundational to the development of modern rocketry, which is largely attributed to German missile development during World War II (WWII).

German development of the V-2 missile during WWII was a vital element in turning mankind's attention toward the heavens. Wernher von Braun, the leader of the V-2 missile development program, is a central character in the story and evolution of rocketry. In the year 1942, von Braun headed a team who launched a V-2 missile 56 miles high over the North Baltic Sea. This is largely considered the first time a man-made object reached Space.

The Cold War sparked a second wave of development in rocket technology, which rapidly evolved during the 1950s and 1960s. In 1957, the Soviet Union launched Sputnik, marking the first time in human history mankind had put an object into orbit. In 1961, the Vostok 1 carried the Russian Cosmonaut Yuri Gagarin once around the Earth, making him the first human in space. In the West, the Apollo Program gave birth to one of the greatest achievements in human history. In 1969, Neil Armstrong became the first person in human history to step foot on the Moon, as part of the Apollo 11 mission. After the Apollo missions, human spaceflight missions stopped, and the development focus turned toward orbital satellites.

Indeed, consistent global satellite coverage emerged in the 1970s, fostering innovation in military and commercial applications. For example, satellite navigation allows Global Position Systems (“GPS”) to help guide and navigate travelers across the globe. Another example is communications satellites, which allow for people all over the world to share information, nearly instantaneously. Now, one of humanity's most profound technological accomplishments is the existing Earth-orbiting infrastructure of satellites. This infrastructure is now an indispensable feature of modern humanity across industry.

Reusable rocket technology has supported the rapid scaling of orbital satellite infrastructure, with the number of satellites in orbit increasing by approximately 800% from the year 2018 to the year 2022. In fact, reusable rockets improved the cost-efficiency of launch to orbit by approximately $1.59B, which is approximately $3.13B when adjusted for inflation, in the last ten years. The reason for the drastic drop is because rocket reusability works to minimize launch costs toward operations and refueling.

Satellites generally have one of three orbital zones: geostationary orbit (GEO) 22,300 miles above sea-level; medium Earth orbit (MEO) 11,000-12,000 miles above sea-level; and low Earth orbit (LEO) 100-1,200 miles above sea-level. Most LEO satellites orbit between 200-600 miles altitude, after which are the strongest parts of the Van Allen Belts, which are radioactive zones with charged particles surrounding Earth. Generally, networks of satellites and ground stations provide three main benefits including: global navigation; global communication; and intelligence information.

First, satellite navigation allows Global Position Systems (“GPS”) to help guide and navigate travelers across the globe. GPS is a radio navigation system allowing the determination of an entities location using satellites. And today GPS is embedded into modern industry for technologies including Uber, Google Maps, and Snapchat. Generally, GPS satellites operate along twelve-hour orbits in MEO. Moreover, most satellites have precise atomic clocks, consistently transmitting a time signal along with orbital information. Then, GPS receivers on Earth calculate positions and altitudes by triangulating signals from at least three satellites.

Second, satellite telecommunications allow for people all over the world to share information, nearly instantaneously. Telecommunications satellites relay radio telecommunication signals via a transponder, creating a communication channel between a source transmitter and a receiver. The study of satellites for telecommunications began in the early 1960s during the Kennedy Administration as part of the Cold War effort, after the Soviet Union successfully launched Sputnik 1 in the year 1957. Today, telecommunications satellites are used for many applications, such as television, telephone, radio, internet, and military applications.

Third, satellite technologies are critical to gathering intelligence information. Indeed, many modern satellites are the result of military innovations during the Cold War. In 1961, a U.S. civilian space agency was created to develop reconnaissance satellites as part of the Cold War. One of the most valuable characteristics for Earth satellites is the ability to pass over large portions of the Earth's surface in a relatively short time. In doing so, satellites can capture meticulously detailed images of any physical location on Earth. Two examples of critical reconnaissance information satellites collect are foreign military information and missile defense data.

As satellite technology evolves, estimates suggest there may soon be more than 40,000 satellites in orbit. As a result, satellite collisions will be become an increasingly greater risk over time. As such, there exists a need for methods for intelligent satellite control, enabling satellites to identify potential collisions and adjust accordingly to ensure structural safety and maintain an optimal orbital trajectory. A solution requires the unification of the two key elements for autonomy in robotics, perception, and decisions. Perception refers to a cars ability to perceive its environment and understand the meaning of the objects within that environment. Decisions refer to a robot's ability to make choice and accordingly interact with its environment.

The most common tool for robotics perception is a Light Detection and Ranging Device (“LIDAR”). LIDAR is a type of optical radar sensor. All LIDAR systems consist of a transmitter and a receiver. The transmitter includes a laser and a beam expander to set the outgoing beam divergence. The receiver includes a telescope to collect backscattered signal, and appropriate optics to direct the return signal from the telescope to a detector, which records the signal. Three main types of LIDAR have been used in space: PMT with Multialkali photocathodes; Si avalanche photodiodes, linear mode, IR-enhanced; Geiger mode Si APD photon counters.

LIDAR sensors start by transmitting infrared light pulses. Then, the pulses travel to the nearest object and backscatter to the receiver. The time it takes for the pulse to travel to the object and return to the receiver is multiplied by the speed of light and divided by two.

$$tc / 2 = d \qquad ( 2 )$$

where t is travel time, c is the speed of light, and d is the distance between the LIDAR sensor and the object. Equation 2 is the LIDAR equation. At its core, the input of a LIDAR system is backscattered laser light, and the output is a point cloud that models an environment.

The two factors that enable LIDAR measurements are lasers with discrete pulses, and the constancy of the speed of light. LIDAR uses discrete pulses to measure distances and the orientation of the lasers allows for the association of a three-dimensional position with each returning pulse. The accuracy of these measurements is made by possible by the constancy of the speed of light c because all light particles travel at 299792458 m/ps. Thus, the time it takes for a laser light pulse to leave a transmitter and return to a receiver is multiplied by its speed, c and divided by two because the photon travels to the object and back. Ultimately, each measurement of distance is recorded in a detector as a data point.

The state of the art in satellite control hardware is field programmable gate arrays (FPGAs), an integrated circuit designed to be configured by a designer after manufacturing. For satellites, the FPGA must be radiation hardened to combat radiation effects in space. The FPGA configuration usually runs on a hardware description language, languages used in integrated circuits. From an architectural perspective, FPGAs contain an array of programmable logic blocks and reconfigurable interconnects, allowing logic blocks to be wired together. Logic blocks can be configured to perform complex convolutional functions. FGPAs typically have both memory and processing capabilities, supporting dynamic programming techniques. For example, the FGPA may be embedded with an artificial intelligence computer program.

Electronic devices utilize processors to carry out various commands necessary to enhance functionality. For example, electronic devices can be designed specifically for use in hostile environments, like space which is highly radioactive. Communications systems used in spacecraft face challenges generally not encountered by Earth based communication systems, such as radiation exposure and mission specific reliability requirements. As such, hardware technology which adapts to various mission specific capabilities in space is proving exceptionally valuable.

For example, the FGPA may be embedded with an artificial intelligence computer program, using a convolutional neural network for computer vision. FGPAs typically have both memory and processing capabilities, to support dynamic programming techniques and operations. The utility for engineers is a configurable array of uncommitted gates with uncommitted wiring channels, which allows for custom application. Each logic unit can be programmed to implement a particular logic function.

Developing as a new stream of research with applications for autonomous control, AI refers to computer systems replicating human thoughtful processes and directed behavior. AI is a field uniquely positioned at the intersection of several scientific disciplines including computer science, applied mathematics, and neuroscience. The AI design process is meticulous, deliberate, and time-consuming-involving intensive mathematical theory, data processing, and computer programming. A specific field within AI, deep learning technologies drive the bleeding edge in innovation.

Deep learning is a type of machine learning concerned with the acquisition of knowledge from large amounts of data. Deep learning involves modeling the human brain with machines to process information. Both artificial and biological neurons receive input from various sources, mapping information to a single output value. Every neuron in the brain is connected to other neurons through architectures called synapses and dendrites-which receive electrical impulses from other neurons. Once the neuron collects enough electrical energy to exceed a certain amount, the neuron transmits an electrical charge to other neurons in the brain. This transfer of information in the biological brain provides the basic framework for the way in which neural networks work.

Consider, deep learning is a process by which neural networks learn from large amounts of data. The internet is the driving force behind most modern deep learning strategies because the internet has enabled humanity to organize and aggregate massive amounts of data. Indeed, the explosion in data collection since the inception of the internet continues to result in increasingly available data, as well as improved deep learning applications and models. This is particularly important because the data—not human programmers—drive progress in deep learning applications. Generally, deep learning systems are developed in three parts: data pre-processing, model design, and learning. A specific type of deep learning program used for robotics control is convolutional neural processing.

Convolutional Neural Networks (CNNs) are a deep learning mechanism for computer vision. The human visual system is the inspiration for the CNNs architectural design. In human vision light enters the eye through the cornea, passing to the lens. As light passes through the lens, the light is convoluted and transferred to the retina. As a mathematical operation, convolution uses two matrices: an input matrix and a kernel. This convolutional operation inspires the architecture for computer vision systems.

Additionally, CNNs contain convolutional layers with learnable parameters. Each kernel is convolved across an input matrix and the resulting output is called a feature map. The full output of the layers is obtained by stacking all of the feature maps to create dimensionality. Classification and state space assignment are common CNN functions. For example, a CNN may classify objects or areas based upon their similarity. In fact, CNNs are specifically used in computer vision because of their ability to map the locality of data. For example, a common computer vision data type is data from a Light Detection and Ranging Device (“LIDAR”). In short, LIDAR is a type of optical radar sensor with a transmitter and a receiver, calculating distances and generating environmental data using a laser and the constancy of light speed. CNNs are the cutting edge in computer vision, but reinforcement learning is state of the art in machine decision making.

Reinforcement learning programs contain three elements: 1 model: the description of the agent-environment relationship; 2 reward the agent's goal; and a 3 policy: the way in which the agent makes decisions. In reinforcement learning, the environment represents the problem. An agent is an algorithm solving the environment or problem. The reward acts as a feedback mechanism, allowing the agent to learn independent of human training. Generally, an optimal policy is developed to maximize value. The optimal policy is developed using a statistical system for machine learning called training, where the software program iterates toward better performance. Performance is defined according to optimal metrics getting a high score in a computer game, using a value function.

A value function may be used to compute the value of a given state and action according to a defined policy. In other words, the value function computes the best decision according to a policy. For example, the value function is equal to the expected sum of the discounted rewards for executing policy over the entire environment, called the episode. The expected future rewards are discounted with a discount factor. The discount factor is typically defined between zero and one. If the discount factor is low, the agent considers present rewards to be worth more and if the discount factor is high, future rewards are worth more-relatively speaking.

The goal for reinforcement learning programming is to identify and select the policy which maximizes expected reward for an agent acting in an environment. In the robotics context, this policy may be captured in a computer program and embedded to hardware for processing and control. Policy evaluation is the process of computing the expected reward from executing a policy in a given environment, which can be used in a general process called policy iteration for computing an optimal policy. In doing so, the agent may take actions in real-time according to a defined policy optimizing control metrics.

Convergent systems are machines capable of sensing their environment and achieving goals, representing the integration of machine decision and perception technologies. Deep reinforcement learning technologies, a specific type of convergent system, are machine learning techniques resulting from a technical convergence in reinforcement and deep learning technologies. Deep reinforcement learning systems have three capabilities that set them apart from all previous AI systems: generalization, learning, and intelligence.

Deep reinforcement learning is a new type of machine learning resulting from the technical convergence of two more mature machine learning methods, deep learning, and reinforcement learning. Generally, there are three different frameworks for deep reinforcement learning: q-networks, policy optimizers, and actor-critic. Q-networks are neural networks embedded in the reinforcement learning architecture using q-learning for predicting rewards, a reinforcement learning technique for training agents. Another example, policy optimizers, iterate toward an optimal policy using a neural network to predict policy performance progress. A third deep reinforcement learning variant is the actor-critic framework which uses an actor neural network and critic neural network to optimize an agent's action selection.

The satellite collision problem, how will we build satellite systems infrastructure to prevent satellites from colliding with one another or orbital debris. There are more than 150 million pieces of debris in Earth orbit. Now, there are 8× more satellites in orbit than there were even five years ago. Collisions have been related to anti-weapons satellites as well as telecommunications satellites.

The loss from Satellite collisions in orbit can cost more than $1B, with negative impacts across industry, such as navigation, telecommunications, and defense. The present disclosure includes methods and a device for helping to reduce the cost of loss from Satellite collisions in orbit by introducing an autonomous satellite capable of computer vision and intelligent decision making regarding orbital guidance and avoidance.

### BRIEF DESCRIPTION OF THE DRAWINGS

FIG. 1 illustrates embodiments of the present disclosure as process for optimized satellite control.

FIG. 2 illustrates embodiments of the present disclosure as a smart satellite with one LIDAR sensor.

FIG. 3 illustrates embodiments of the present disclosure as a process for automated satellite collision avoidance.

FIG. 4 illustrates embodiments of the present disclosure as a smart satellite with two LIDAR sensors.

### DETAILED DESCRIPTION OF THE INVENTION

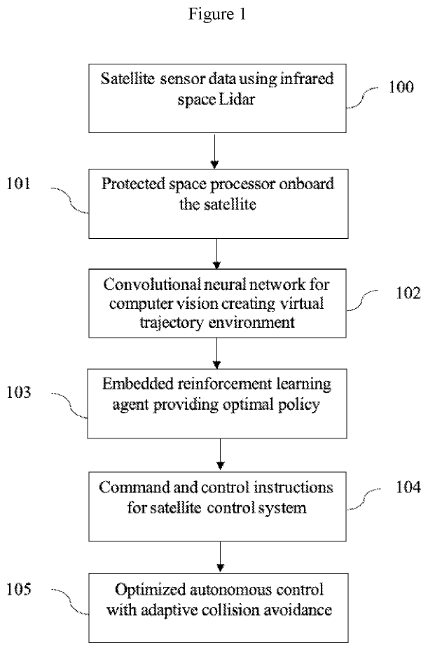

FIG. 1 illustrates embodiments of the present disclosure as a process for optimized satellite control, including satellite sensor data using infrared space Lidar 100; aggregating in a protected space processor 101; further being processed by a convolutional neural network 102; and reinforcement learning agent 103; generating commands 104; for optimizing collision avoidance 105.

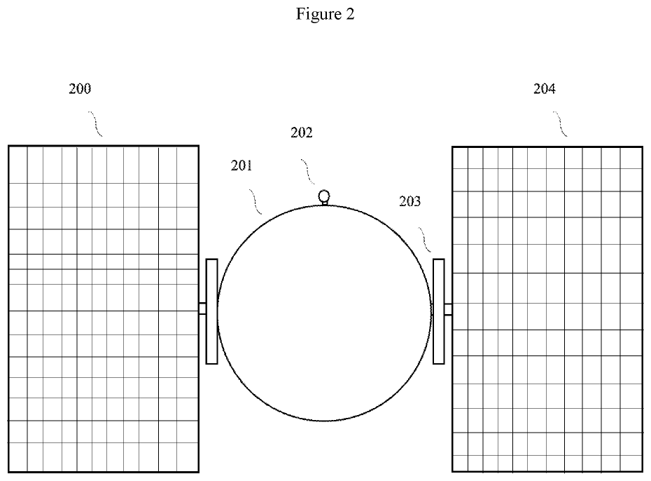

FIG. 2 illustrates embodiments of the present disclosure as a smart satellite device with one LIDAR sensor including a left side panel 200; a satellite body 201; one LiDAR sensor 202; a panel connector 203; and a right panel 204.

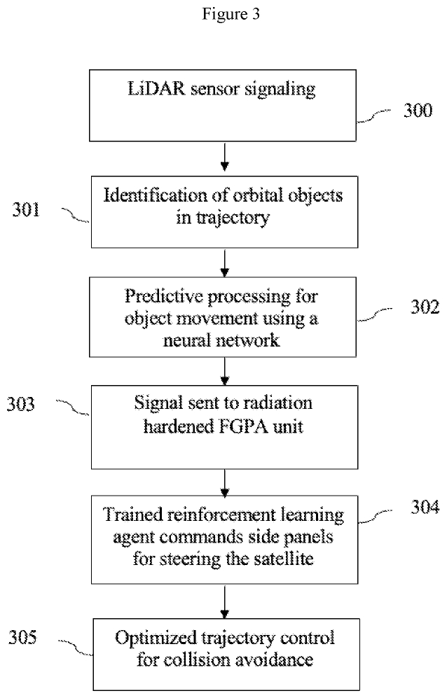

FIG. 3 illustrates embodiments of the present disclosure as a process for automated satellite collision avoidance including a LiDAR sensor signaling 300; the identification of orbital objects in trajectory 301; the predictive processing of object movement using a neural network 302; a signal sent to radiation hardened FGPA unit 303; a trained reinforcement learning agent commanding the side panels for steering the satellite 304; to allow for optimized trajectory control and collision avoidance 305.

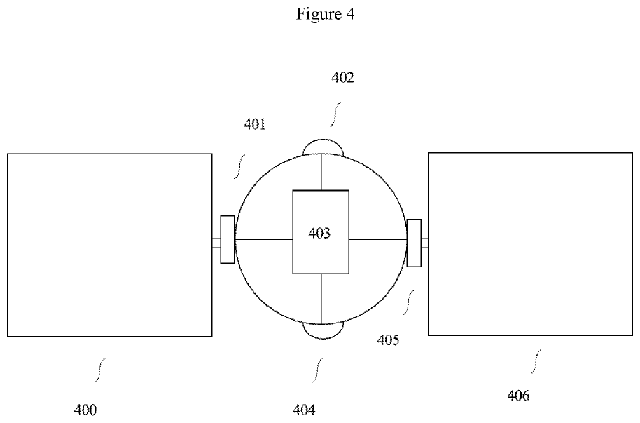

FIG. 4 illustrates embodiments of the present disclosure as a smart satellite with two LIDAR sensors including a left side panel 400; a left side panel connector 401; a top LiDAR sensor 402; a radiation hardened FGPA processor 403; a bottom LiDAR sensor 404; a left panel connector 405; and a right panel 406.

In certain embodiments, the present disclosure is a process for optimized satellite control. In such embodiments, the process includes a satellite sensor data using infrared space Lidar 100. The data then aggregates in a protected space processor 101 where it the data is further being processed by a convolutional neural network 102 which makes predictions about the motions of orbital objects and a reinforcement learning agent 103 generating commands 104 for optimizing satellite safety and collision avoidance 105.

In certain embodiments, the present disclosure is a smart satellite device. In such embodiments, the smart satellite device includes one LIDAR sensor 202 mounted on top of the satellite. The device also includes a left panel 200 and a right panel 204. The device further includes a satellite body 201 and two connectors 203 joining the satellite body and the side panels.

In certain embodiments, the present disclosure is a process for automated satellite collision avoidance. In such embodiments, the process includes a LiDAR sensor searching, sensing, and signaling an on-board processor 300; regarding the identification of orbital objects in the satellite's potential flight path 301. The on-board processor uses a neural network 302 for predicting the movement of identified objects in the satellite's potential flight path and sends signals sent to a second radiation hardened processor 303. The second radiation herded processor includes an embedded reinforcement learning software for steering the satellite 304, to allow for optimized trajectory control and collision avoidance 305.

In certain embodiments, the present disclosure is a smart satellite device. In such embodiments, the smart satellite device includes a top LiDAR sensor 402 and a bottom LiDAR sensor 404. In such embodiments, the device also includes a left panel 400 and a right panel 406. The device also includes a radiation hardened FGPA processor 403, which commands satellite control by manipulating the side panels using a left panel connector 401 and a right panel connector 405.

In certain embodiments, the present disclosure is a process for optimized satellite control. In such embodiments, the process includes a satellite sensor data using LIDAR 100. The LIDAR data may then be collected by a first radiation hardened processor 101 where it the data is further processed by a convolutional neural network 102. In certain embodiments, the first radiation hardened processor may send output signals to a second radiation hardened processor, which makes predictions about the motions of orbital objects using an embedded reinforcement learning agent 103. The reinforcement learning agent may produce commands 104 for optimizing satellite safety and collision avoidance 105.

In certain embodiments, the present disclosure is a process for optimized satellite control. In such embodiments, the process includes a satellite sensor data using LIDAR 100. The LIDAR data may then be collected by a radiation hardened processor 403 where it the data is further processed by a convolutional neural network 102 which makes predictions about the motions of orbital objects using an embedded reinforcement learning agent 103. The neural network and reinforcement learning agent may then produce commands 104 manipulating the left side panel connector 401 and the right panel connector 405 to steer the satellite and optimize satellite trajectory control and collision avoidance 305.

In certain embodiments, the present disclosure is a smart satellite device. In such embodiments, the smart satellite device includes one LIDAR sensor 202 mounted on top of the satellite for sensor detection and signaling 300. In such embodiments, the device also includes a left side panel 400 and a right panel 406, which connect to the satellite body 201 via a left panel connector 401 and a right panel connector 405 respectively.

In certain embodiments, the present disclosure is a method for optimized satellite control. In such embodiments, the method includes a satellite sensor collecting data using a LIDAR sensor 100; the sensor sending sensor data, via a wire within the satellite body 201, to a radiation hardened space processor 403. In the radiation hardened processor, the data undergoes further processing by a convolutional neural network 302 making predictions about the motions of orbital objects. The neural network next sending predictions to a reinforcement learning agent 304 that generates commands for optimizing satellite safety and collision avoidance 105.

In certain embodiments, the present disclosure is a smart satellite device. In such embodiments, the device comprising one LIDAR sensor mounted on top of the satellite body 402. The satellite body 201 joins a left panel 200 and a right panel 204 via a left connector 401 and a right connector 405. The two connectors communicate with an artificial intelligence computer program embedded in a radiation hardened processor 403 stored within the satellite body 201. In such embodiments, the reinforcement learning agent software is a pre-trained model, which controls commands for satellite steering in orbit 304 to optimize satellite safety 305.

In certain embodiments, the present disclosure is a method for optimized satellite control. In such embodiments, the method comprising a LIDAR sensor searching and sensing a trajectory environment 100 and sending orbital trajectory path data to an on-board processor 403. Within the radiation hardened processor, an artificial intelligence computer program, using machine learning and analyzes the data regarding the orbital trajectory path 103. In certain embodiments, a machine learning software program may predict the movement of possible objects in the satellite's potential flight path 302. The predictions may be further processed by a second artificial intelligence computer program to derive knowledge for steering 304 the satellite and command the manipulation 104 of the left panel 200 and right panel 204 for optimized trajectory control and collision avoidance.

In certain embodiments, the present disclosure is a process for automated satellite collision avoidance. In such embodiments, the process includes a LIDAR sensor searching, sensing 100 and sending information a processor 300 regarding the identification of orbital objects in the satellite's potential flight path 301. The processor may use a neural network 302 for predicting the movement of identified objects in the satellite's potential flight path and sends signals sent to a second radiation hardened processor 303. The second processor includes an embedded reinforcement learning software for steering the satellite 304, to allow for optimized trajectory control and collision avoidance 305.

In certain embodiments, the present disclosure is a smart satellite device. In such embodiments, the smart satellite device includes a top LiDAR sensor 402 and a bottom LiDAR sensor 404 which sense the trajectory path 100 and send information to a processor 101. In such embodiments, the device also includes a left panel 400 and a right panel 406. The device may also include a radiation hardened FGPA processor 403, which commands satellite control by manipulating the right side and left side panel using a left panel connector 401 and a right panel connector 405. Moreover, the commands may manipulate the right panel and left panel using either of a continuous software control system or an asynchronous software system, wherein a selection may be made autonomously with a goal orientation toward optimizing safety and collision avoidance 105.

In certain embodiments, the present disclosure is a method for machine perception by collecting orbital data about a satellite's environment. In such embodiments, the method may include a satellite body 201 with a top LIDAR data sensor 402 and a bottom LIDAR data sensor 404. In certain embodiments of the disclosure, satellite sensors mounted on the satellite in various positions collect data about the satellite's environment. The sensor types may include GPS, radar, LIDAR, or inertial navigation. Three main types of LIDAR have been used in space: PMT with Multialkali photocathodes; Si avalanche photodiodes, linear mode, IR-enhanced; Geiger mode Si APD photon counters.

In certain embodiments, the present disclosure the artificial intelligence computer program adjusts satellite panels based on processing results from LIDAR data. In certain embodiments, forms of Equation 3 and Equation 4 may be used to calculate movements in orbital trajectory by the satellite given adjustments in the side panels. The centripetal force magnitude on mass m moving at tangential speed v along a path with radius of curvature r.

$${a}_{c} = {lim}_{Δ t \to 0} \frac{\vert Δ v \vert}{Δ t} \qquad ( 3 )$$

Where a_{c} is centripetal acceleration and Av measures the difference in velocity vectors.

$${F}_{c} = γ mvw \qquad ( 4 )$$

The centripetal force is measures change in relativistic momentum. γ is the Lorentz factor; w is orbital period, and v is the tangential velocity.

In certain embodiments, a commonly used back propagation algorithm is the Chain Rule, which states.

$${lim}_{Δ t \to 0} \frac{Δ y}{Δ t} = \frac{Δ y}{Δ x} = \frac{Δ y}{Δ x} \cdot \frac{Δ x}{Δ t} \qquad ( 5 )$$

Equation 5 is the chain rule. Here, y is a function of x and x is a function t. The derivative of y with respect to t is

$${lim}_{Δ t \to 0} \frac{Δ y}{Δ t} .$$

In other words, the chain rule takes the dot product of the derivative of y with respect to x and the derivative x with respect to t. In short, the Chain Rule allows the neural network, to update the weights of its network to learn the appropriate associations of syntax and semantics.

In certain embodiments, the present disclosure is a method for machine intelligence using a decision-making software for satellite steering for safety. In such embodiments, the method may include a satellite body 201 with a left panel connector 401 and a right panel connector 405.

$$\begin{matrix}{x}_{l} \to {x}_{l + 1} \to \\ {x}_{m} \to {x}_{m + 1} \to {x}^{°} \\ {x}_{n} \to {x}_{n + 1}\end{matrix} \qquad ( 6 )$$

Equation 6 is a forward processing neural network. In general, neural networks are appropriate for problems where specific prior nodes influence later nodes in the network because the neural network processes sequences of data one element at a time. Thus, neural networks 302 may be used for satellite computer vision because vision is often defined through a problem framework requiring memory. The task of updating the network's weights, representing synapses, is solved with brute force. While the overall technique is called back propagation, which takes in a window size and computes error.

In certain embodiments of the present disclosure, various formal models may be deployed to facilitate deep intelligence networks.

$$[ {x}_{l} {x}_{p} {x}_{a} ] ⊗ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊗ [ {x}_{l} {x}_{p} {x}_{a} ] \qquad ( 7 )$$

$$[ {x}_{l} {x}_{p} {x}_{a} ] ⊕ [ \begin{matrix}{x}_{l} \\ {x}_{p} \\ {x}_{a}\end{matrix} ] ⊗ [ \begin{matrix}{x}_{l} \\ {x}_{p} \\ {x}_{a}\end{matrix} ] ⊕ [ {x}_{l} {x}_{p} {x}_{a} ] \qquad ( 8 )$$

Equation 7 and Equation 8 are mathematical architectures for multilayer neural networks. The operators in Equation 7 and Equation 8 are switched to allow for both linear and nonlinear processing within the several layers of a neural network architecture. In such embodiments, neural networks maybe used to process incoming LIDAR data to generate a point-cloud environment 102 and to then process the data to identify potential collisions and inform intelligent decision making.

In embodiments of the disclosure, various partial derivative calculations may be used to update the neural networks weights through backpropagation. Backpropagation updates the weights for the neural network to optimize performance.

$$\frac{{\partial }^{2} {x}^{*}}{\partial {l}^{2}} + \frac{{\partial }^{2} {x}^{*}}{\partial {p}^{2}} + \frac{{\partial }^{2} {x}^{*}}{\partial {a}^{2}} = {min}_{{x}^{*}} {x}^{*} ( {x}_{i}^{°} - {x}_{j}^{°} ) \qquad ( 9 )$$

$$\frac{{\partial }^{2} {x}^{*}}{\partial {l}^{2}} + \frac{{\partial }^{2} {x}^{*}}{\partial {p}^{2}} + \frac{{\partial }^{2} {x}^{*}}{\partial {a}^{2}} = {min}_{{x}^{*}} {x}^{*} ( {x}_{j}^{°} - {x}_{i}^{°} ) \qquad ( 10 )$$

$$\frac{{\partial }^{2} {x}^{*}}{\partial {l}^{2}} + \frac{{\partial }^{2} {x}^{*}}{\partial {p}^{2}} + \frac{{\partial }^{2} {x}^{*}}{\partial {a}^{2}} = {min}_{{x}^{*}} {x}^{*} \vert {x}_{i}^{°} - {x}_{j}^{°} \vert \qquad ( 11 )$$

Equation 9 and Equation 10 are variations of partial differential equations. Equation 11 is an absolute form of Equation 9 and Equation 10. In such embodiments, Equation 9, Equation 10, or Equation 11 may be used to update weight parameters for a computer vision algorithm using a convolutional neural network 102.

In embodiments of the disclosure, the DQN algorithm may be used to integrate the computer vision and decision-making elements of the satellite. The DQN algorithm's most important aspect is the Bellman Equation. The algorithm continues perpetually until the convergence of the Q-value function. The convergence of the Q-value function represents Q* and satisfies the Bellman Equation. Equation 12 is the Bellman Equation.

$${Q}^{*} ( s , a ) = {E}_{{s}^{′} \sim ε} [ r + γ {max}_{{a}^{′}} {Q}^{*} ( {s}^{′} , {a}^{′} ) \vert s , a ] . \qquad ( 12 )$$

Here, E_{s'˜ε} refers to the expectation for all states, r is the reward, γ is a discount factor. Additionally, the max function describes an action at which the Q-value function takes its maximal value for each state-action pair. An agent's optimal policy π* corresponds to taking the action in each state defined by Q*. In short, the Bellman Equation expresses the relationship between the value of a state and the values of its successor states. The algorithm continues perpetually until the Q-value function's convergence with an approximate maximum.

In certain embodiments, the software may be first trained in a simulation to develop a trained reinforcement learning agent 304. the Bellman Equation does two things; it defines the optimal policy and allows the agent to consider the reward in its present state as greater relative to similar rewards in future states. In other words, the Bellman Equation is a Q-learning algorithm defining the optimal policy by expressing the relationship between the value of a state and the values of future states. In such embodiments, the state represents points along an orbital trajectory.

In certain embodiments, a neural network 302 may be used as an approximator for a state-action value function, allowing for more efficient programming and model development. However, one issue that arises is that the value of Q(s, a) must be computed for every state-action pair, which may be computationally infeasible. One solution is to use a function approximator to estimate the Q-value function. Equation 13 is a function approximator for a Q-network.

$$Q ( s , a ; ∅ ) \approx ( s , a ) . \qquad ( 13 )$$

Here, Ø represents the function parameters. Thus, the Q-value correlates with an optimal policy, telling the agent which actions to take in any given state.

In embodiments of the disclosure, Proximal Policy Optimization (“PPO”) is a general policy optimization technique. In contrast to the DQN algorithm, PPO is an on-policy algorithm, meaning it does not learn from old data and instead directly optimizes policy performance. One advantage of the PPO model is utility in environments with either discrete or continuous action spaces. PPO computes policy gradient estimation and iterating with a stochastic gradient optimization algorithm. In other words, the algorithm continuously updates the agent's policy based on the old policy's performance. In such embodiments, the algorithm converges to an optimal policy for trajectory control 305.

In certain embodiments, the PPO update is a method of incremental improvement for a policy's expected return. The policy informs the decision-making element for an artificial intelligence computer program controlling the satellite. Essentially, the algorithm takes multiple steps via gradient descent to maximize the objective. The PPO algorithm's key to the success is obtaining good estimates of an advantage function. The advantage function describes the advantage of a particular policy relative to another policy. The algorithm's goal is to make the largest possible improvement on a policy, without stepping so far as to cause performance collapse. To that end, PPO relies on clipping the objective function to remove incentives for the new policy to step far from the old policy. In essence, the clipping serves as a regularize, minimizing incentives for the policy to change dramatically. As a result, in such embodiments, PPO is used to optimize satellite control with adaptive collision avoidance.

In certain embodiments, the present disclosure provides methods where an artificial intelligence computer program identifies and then classifies an object in the satellites orbit based on the object's size and then makes an appropriate adjustment. In such embodiment, the satellite may sense the orbital environment with a sensor using infrared space LIDAR 300. Next, the data may be transmitted to an onboard processor. Then, a trained reinforcement learning agent 103 may make decisions about panel adjustment according to the LIDAR data received.

In certain embodiments of the present disclosure, the satellite may use a turbo engine to generate thrust. In such embodiments, this procedure may be used to minimize risk of loss during avoidance procedure. Loss risks include any data loss resulting from disturbance in reception or a change in orbital path. In such embodiments, given the absence of external forces in space delta-vee may be calculated.

$$Δ v = {\int }_{{t}_{0}}^{{t}_{1}} \vert \dot{v} \vert dt \qquad ( 14 )$$

Given a constant thrust.

$$\frac{v}{\vert v \vert} \qquad ( 15 )$$

Delta-vee simplifies too the magnitude of change in velocity.

$$Δ v = \vert {v}_{1} - {v}_{0} \vert \qquad ( 16 )$$

If s does need to change trajectory, then the software calculates a minimum change, and readjustment to the previous trajectory with the goal being to not cause further problem or delay.

$$\begin{matrix}{x}_{n} \to {x}_{n + 1} \to \\ {x}_{m} \to {x}_{m + 1} \to {x}^{°} \\ {x}_{n} \to {x}_{n + 1}\end{matrix} {x}^{*} \begin{matrix}← {x}_{l + 1} ← {x}_{l} \\ {x}^{°} ← {x}_{m + 1} ← {x}_{m} \\ {x}_{n + 1} ← {x}_{n}\end{matrix} \qquad ( 17 )$$

A method for optimized satellite control, the method comprising a LIDAR sensor 300 searching and sensing a trajectory environment, and signaling data regarding the identification of orbital objects in the satellite's potential flight path to an on-board processor; wherein the on-board processor analyzes the data regarding orbital objects in the satellite's flight path using a neural network; the neural network predicts the movement of identified objects in the satellite's potential flight path and further sending signals to an embedded expert intelligence software program. The embedded expert intelligence software program processes the signals and steering the satellite for optimized trajectory control, collision avoidance, and orbital distance minimization.

For satellite constellations, a big problem is how to navigate the rapidly growing traffic in space. In certain embodiment, the present disclosure provides the solution by allowing constellations of satellites to be pre-programed to identify one another automatically. In such embodiments, reinforcement learning agents may be trained to navigate for collision avoidance by steering the side panels 304. For example, the right panel 406 by rotating the panel connector 405.

It is to be understood that while certain embodiments and examples of the invention are illustrated herein, the invention is not limited to the specific embodiments or forms described and set forth herein. It will be apparent to those skilled in the art that various changes and substitutions may be made without departing from the scope or spirit of the invention and the invention is not considered to be limited to what is shown and described in the specification and the embodiments and examples that are set forth therein. Moreover, several details describing structures and processes that are well-known to those skilled in the art and often associated with satellites and satellite control or other satellites are not set forth in the following description to better focus on the various embodiments and novel features of the disclosure of the present invention. One skilled in the art would readily appreciate that such structures and processes are at least inherently in the invention and in the specific embodiments and examples set forth herein.

One skilled in the art will readily appreciate that the present invention is well adapted to carry out the objectives and obtain the ends and advantages mentioned herein as well as those that are inherent in the invention and in the specific embodiments and examples set forth herein. The embodiments, examples, methods, and compositions described or set forth herein are representative of certain preferred embodiments and are intended to be exemplary and not limitations on the scope of the invention. Those skilled in the art will understand that changes to the embodiments, examples, methods and uses set forth herein may be made that will still be encompassed within the scope and spirit of the invention. Indeed, various embodiments and modifications of the described compositions and methods herein which are obvious to those skilled in the art, are intended to be within the scope of the invention disclosed herein. Moreover, although the embodiments of the present invention are described in reference to use in connection with satellites or launch vehicles, ones of ordinary skill in the art will understand that the principles of the present inventions could be applied to other types of aerial vehicles or apparatus in a wide variety of environments, including environments in the atmosphere, Earth orbit, in space, on the ground, and underwater.

I claim:

1. A method for optimized satellite control, the method comprising a satellite with one LIDAR sensor, collecting environmental data via electron pulses; the data aggregating in a protected space processor and undergoing further processing by a neural network making predictions about the motions of orbital objects; sending predictions to a reinforcement learning agent; generating commands for optimizing satellite safety and collision avoidance.

2. The method of claim 1 wherein, the mounted LIDAR sensor is an infrared space LIDAR sensor.

3. The method of claim 1 wherein, the neural network making predictions about the motions of orbital objects is a convolutional neural network.

4. The method of claim 1 wherein, the neural network making predictions about the motions of orbital objects is a recurrent neural network.

5. The method of claim 1 wherein, the neural network making predictions about the motions of orbital objects is a deep neural network.

6. The method of claim 1 wherein, the commands for optimizing satellite safety and collision avoidance manipulate a right panel connector, connecting a satellite body to a right panel and a left panel connector, connecting a satellite body to a left panel.

7. The method of claim 1 wherein, the satellite further comprises two LIDAR sensors, wherein one LIDAR sensor is mounted on top of the satellite body and one LIDAR sensor is mounted on the bottom of the satellite body.

8. A smart satellite device, the device comprising one LIDAR sensor mounted on top of the satellite body, wherein the satellite body joins a left side panel and a right panel via connectors, the connectors communicating with an artificial intelligence computer program embedded in a radiation hardened processor, the radiation hardened processor being stored within the satellite body.

9. The device of claim 8 wherein, the satellite body is made of a niobium metal alloy.

10. The device of claim 8 wherein, the left side panel, the right panel, the left side panel connector, and the right panel connector are made of a niobium alloy.

11. The device of claim 8 wherein, the device comprises two LIDAR sensors; a top LIDAR sensor mounted on top of the satellite body, and a bottom LIDAR sensor mounted on the bottom of the satellite body.

12. The device of claim 8 wherein, the device comprises two radiation hardened processors; the first radiation hardened processor containing an embedded deep learning software program processing LIDAR sensor data to make predictions; sending information to the second radiation hardened processor; the second radiation hardened processor further comprising a second embedded deep learning software, processing the predictions to make intelligent decisions for generating satellite control commands, the commands optimally controlling the satellite for orbital safety by adjusting trajectory for collision avoidance as needed.

13. The device of claim 12 wherein, the second radiation hardened processor further comprises an expert software program; the expert software program processing the predictions from the deep learning software program to make intelligent decisions for generating optimized satellite control commands.

14. The device of claim 12 wherein, the device of claim 12 wherein, the second radiation hardened processor further comprises a reinforcement learning software program; the reinforcement learning software program processing the predictions from the deep learning software program to make intelligent decisions for generating optimized satellite control commands.

15. A method for optimized satellite control, the method comprising a LIDAR sensor searching and sensing a trajectory environment, and signaling data regarding the identification of orbital objects in the satellite's potential flight path to an on-board processor; wherein the on-board processor analyzes the data regarding orbital objects in the satellite's flight path using a neural network; the neural network predicting the movement of identified objects in the satellite's potential flight path and further sending signals to an embedded reinforcement learning software program; the embedded reinforcement learning software program processing the signals and accordingly steering the satellite for optimized trajectory control and collision avoidance.

16. The method of claim 15 wherein, the reinforcement learning software program processing the signals of the neural network, controlling the left side panel and right panel asynchronously.

17. The method of claim 15 wherein, the reinforcement learning software program processing the signals of the neural network, controlling the left side panel and right panel concurrently.

18. The method of claim 15 wherein, the on-board processor is a radiation hardened FGPA.

19. The method of claim 15 wherein, there are two independent on-board processors, computing in parallel and communicating between one another to generate optimal steering commands.

20. The method of claim 15 wherein, the neural network predicting the movement of identified objects in the satellite's potential flight path sends signals to an embedded expert system software program; the embedded expert system software program processing the signals and steering the satellite for optimized trajectory control, collision avoidance, and orbital distance minimization.
